(19) United States
(12) Patent Application Publication
(10) Pub. No.: US 2007/0051144 A1
(43) Pub. Date: Mar. 8, 2007

(54) Rotation pipe of handle

(76) Inventors: Lien-Hsi Huang, Kaohsiung (TW); Kuang-Chun Chiang, Kaohsiung Hsien (TW)

Correspondence Address: LOWE HAUPTMAN BERNER, LLP, 1700 DIAGONAL ROAD, SUITE 300, ALEXANDRIA, VA, 22314, US

(21) Appl. No.: 11/219,799

(22) Filed: Sep. 7, 2005

(51) Int. Cl. E05B 13/10

(52) U.S. Cl. 70/224

(57) ABSTRACT

A rotation pipe of handle has a bushing, an arrester and a compression spring. An axial extended slot with two closed ends is defined in a periphery wall of the bushing. A first blind hole is defined in the arrester, and a side channel is defined in a proximal end of the slot, wherein a second blind hole is defined. The compression spring is secured in the slot, with a distal end inserted to the first blind hole, and a proximal end inserted to the second blind hole. The assembly process of the rotation pipe is convenient and fast.

### BACKGROUND OF THE INVENTION

1. Field of the Invention

The present invention relates to a rotation pipe of a door handle, and particularly relates to a rotation pipe mounted on a door handle to control a latch bolt.

2. Description of Related Art

With reference to FIG. 6, two handles (50) are oppositely mounted on respective faces of a door (A), and an automatic protruding latch bolt (51) is provided at a side of the door (A). The latch bolt (51) can be retracted by rotating one of the handles (50). Each handle (50) comprises a base (52) mounted between the handle (50) and the door (A), an elongated shaft (53) extending through the door (A) and the two bases (52), and a rotating pipe (60) is provided to sleeve over the shaft (53). In this way, the latch bolt (51) can be controlled by rotating the handle (50).

With reference to FIG. 6 and FIG. 7, an arrester (62) is mounted at the wall of the rotating pipe (60) which is received in a first slot (501) defined in the handle (50), whereby the handle (50) is combined to the rotating pipe (60). The rotating pipe (60) has a bushing (61), wherein an axial extended second slot (610) is defined therein that has a proximal end and a distal end, the arrester (62) is provided in the distal end of the second slot (610) on the bushing (61), and two supporters (611) curved downward are formed below the second slot (610). A compression spring (64) is secured in the second slot (610) and is above the two supporters (611), and a proximal end of the compression spring (64) is pressed by an inner wall of the bushing (61), and a distal end of the compression spring (64) is inserted into a jack (620) defined in the arrester (62). In this way, the compression spring (64) is curved upward, whereby the arrester (62) obtains an elastic force from the compression spring (64), such that a lug (621) formed on the arrester (62) stands out of a periphery wall of the bushing (61), for being received in the first slot (501) of the handle (50).

However, there are some disadvantages in the above handle structure:

1. It is troublesome to assemble. With reference to FIGS. 8A and 8B, the arrester (62) is firstly mounted on the bushing (61), then the compression spring (64) is gripped by tools, to insert the distal end of the spring (64) into the jack (620). Next, the proximal end is pressed by the inner wall of the bushing (61), and a middle section of the spring (64) is above the two supporters (611). At that time, the arrester (62) is supported by the compressed spring (64). To prevent a possible sliding of the spring (64), a section of the compressed spring (64) between the two supporters (611) is made to be curved downward to be further secured in the second slot (610), and the compression spring (64) will not slide out while the arrester (62) is kept being supported. In this way, the step of inserting the compression spring (64), being made to be curved downward, is inconvenient. Furthermore, as the compression spring (64) is slender, it is difficult for inserting into the jack.

2. Accordingly, the cost will increase due to the complex manufacturing process.

FIG. 9 shows another type of rotating pipe (70), which also has a bushing (71), wherein an axial extended slot (710) is defined in the bushing (71) and has a proximal end and a distal end. An arrester (72) is provided at the proximal end of the slot (710), a compression spring (73) is secured in the slot (710) with a proximal end pressed by an inner wall of the bushing (71) and a distal end is inserted to a jack (720) of the arrester (72). In the middle of the slot (710), a supporter (711) is formed, which is curved downward to hold the compression spring (73). Two pressing members (712) respectively extend from two sides of the slot (710) in the distal end, giving a pressing force to the distal end of the compression spring (73), so a proximal end of the compression spring (73) gives an elastic force to the arrester (72) whereby a lug (721) formed on the arrester (72) stands out of the periphery wall of the bushing (71).

FIG. 10 shows the steps of assembling the compression spring (73) and the other components of the pipe (70). The arrester (73) is firstly mounted on the proximal end of the slot (710) of the bushing (71), and then two pressing members (712) are formed in the distal end of the slot (710), and a supporter (711) is formed on the middle of the slot (710). The compression spring (73) is bent to a U-shape previously, and then the proximal end of the compression spring (73) is inserted into the jack (720). Finally, the distal end of the compression spring (73) is inserted below the two pressing members (712).

The assembly steps shown in FIG. 9 and 10 still involve a complex process that increases the relative cost.

Therefore, the invention provides a rotation pipe of handle to mitigate or obviate the aforementioned problems.

### SUMMARY OF THE INVENTION

The main objective of the present invention is to provide a rotation pipe having a bushing, an arrester mounted on the bushing and a compression spring. An axial extended slot with two closed ends is defined in the bushing, and a notch is defined in a distal end of the slot. A lug formed on the arrester supported by the compression spring stands out from the notch. A side channel is defined beside the slot in a proximal section. In this way, the compression spring is irremovably secured in the slot.

The assembly steps are: a distal end of the spring is inserted to a first blind hole of the arrester, and a proximal end of the compression spring is inserted to a second blind hole of the bushing, which is more convenient than the conventional rotation pipe.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a rotation pipe in accordance with this invention;

FIG. 2 is a perspective view in part section of the rotation pipe in accordance with this invention;

FIG. 3 is a part sectional view when the rotation pipe of this invention is mounted on the handle;

FIG. 4 is a schematic illustration showing the steps of assembling the pipe with a compression spring in first embodiment in accordance with this invention;

FIG. 5 is a schematic illustration showing the steps of assembling a compression spring in a second embodiment in accordance with this invention;

FIG. 6 is a perspective view of a conventional rotation pipe mounted on a handle;

FIG. 7 is a perspective view of a first kind of the conventional rotation pipe;

FIG. 8A is an operational exploded perspective view of the conventional rotation pipe in FIG. 7 showing the steps of installing a compression spring in the first kind of the conventional rotation pipe;

FIG. 8B is side plan view in partial cross section of the conventional rotation pipe in FIG. 7 showing the steps of installing a compression spring in the first kind of the conventional rotation pipe;

FIG. 9 is a perspective view of a second kind of the conventional rotation pipe; and

FIG. 10 is a schematic illustration showing the steps of installing a compression spring in a second kind of the conventional rotation pipe.

### DETAILED DESCRIPTION OF THE PREFERRED EMBODIMENT

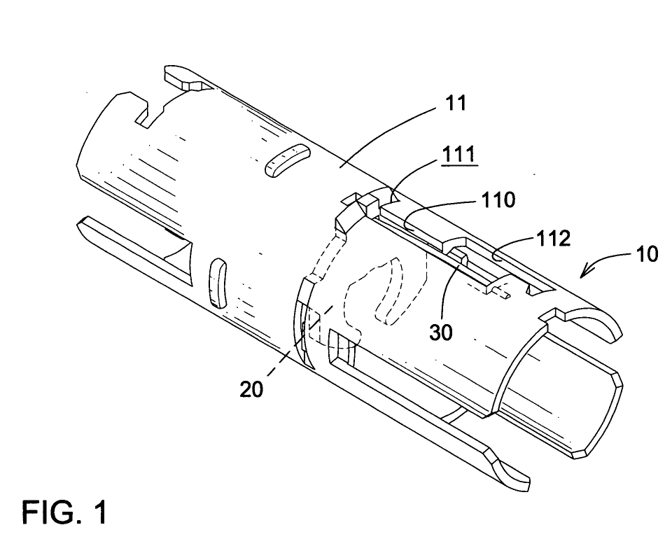

With reference to FIGS. 1-3, a rotation pipe (10) comprises a bushing (11), an arrester (20) and a compression spring (30). An axial extended slot (110) with two closed ends is defined in the bushing (11), and a distal end of the slot (110) has a notch (111) defined therein, from which a lug (21) of the arrester (20) stands out. In the middle of the slot (110), a supporter (113) curved downward is made to hold the compression spring (30).

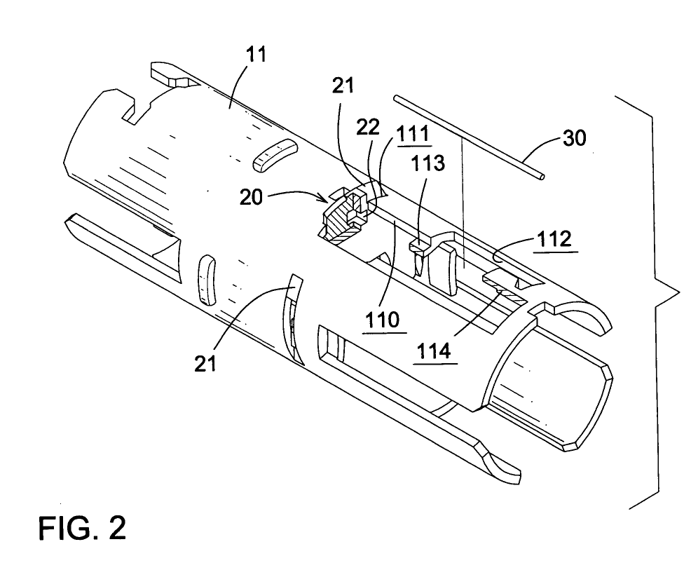

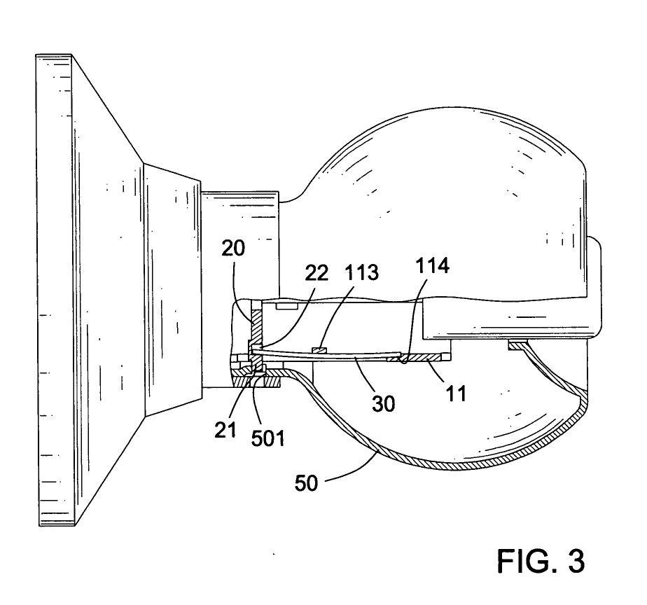

With reference to FIG. 2 and FIG. 3, the arrester (20) has a first blind hole (22) open to the slot (110), and a side channel (112) is defined in a proximal end of the slot (110) beside the slot (110), and in a proximal wall of the side channel (112), a second blind hole (114) is defined therein. The compression spring (30) is linear, a middle section of which is held above the supporter (113), and two ends of the compression spring (30) are respectively inserted to the two blind holes (22), (114), which limits the axial movement of the compression spring (30). In addition, as shown in FIG. 3, the segment of the compression spring (30) near the end inserted into the first blind hole (22) is supported on the supporter (113) and is curved, which further provides an elastic force to the arrester (20), whereby the arrester (20) is received in a first slot (501) defined in the handle (50)

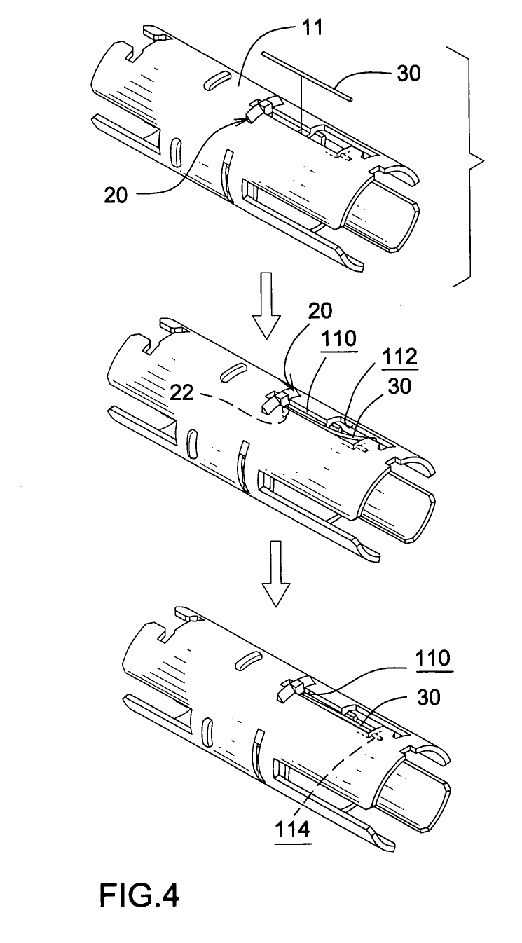

Referring to the assembly steps as shown in FIG. 4, the arrester (20) is firstly mounted on the bushing (11), then the compression spring (30) is secured in the slot (110); a distal end of the compressed spring (30) is inserted into the first blind hole (22) and then a proximal end of the compression spring (30) is inserted into the second blind hole (114), which is a convenient assembly process.

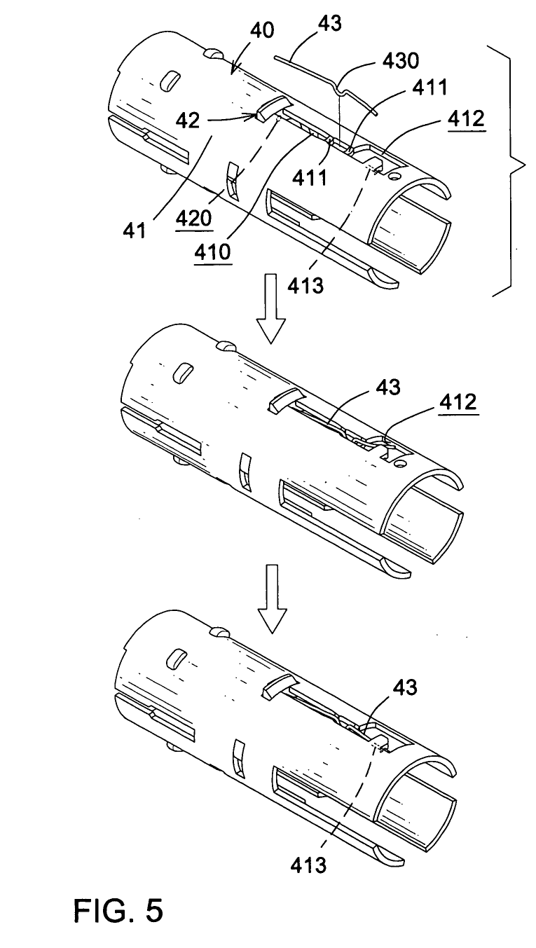

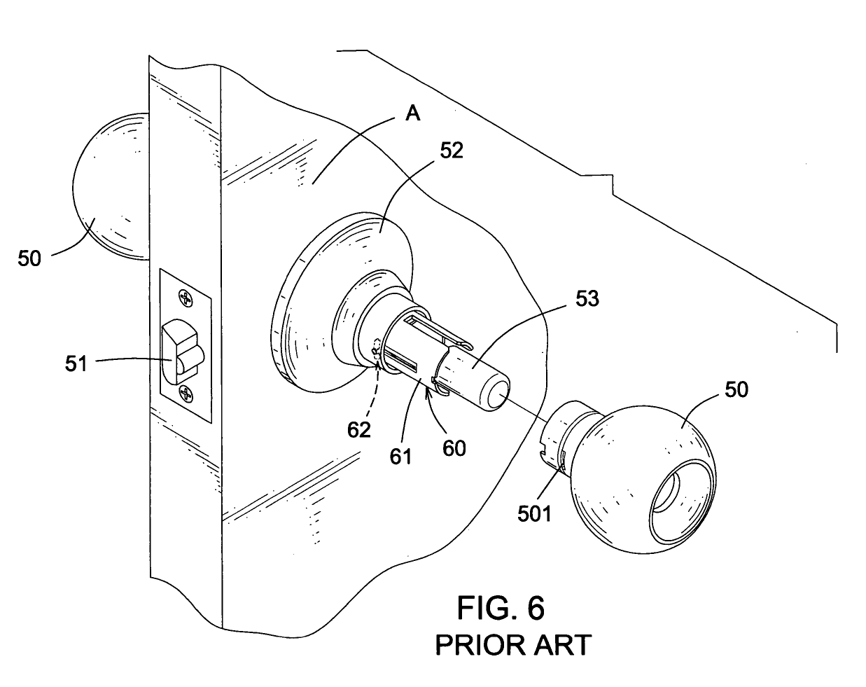

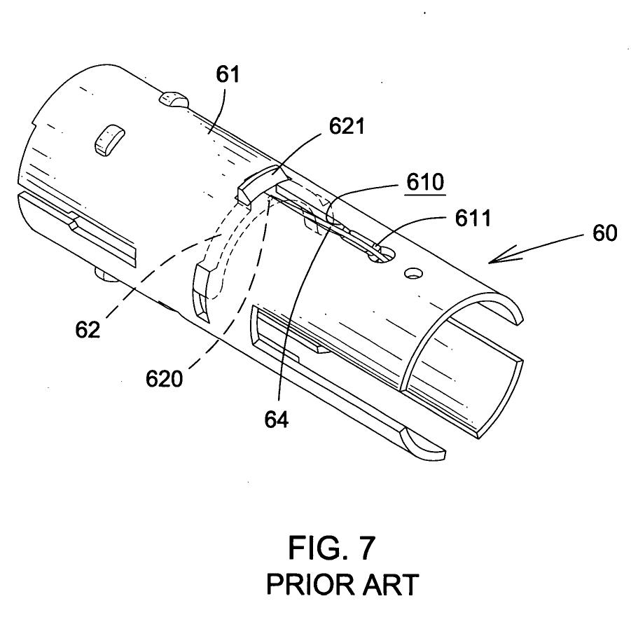

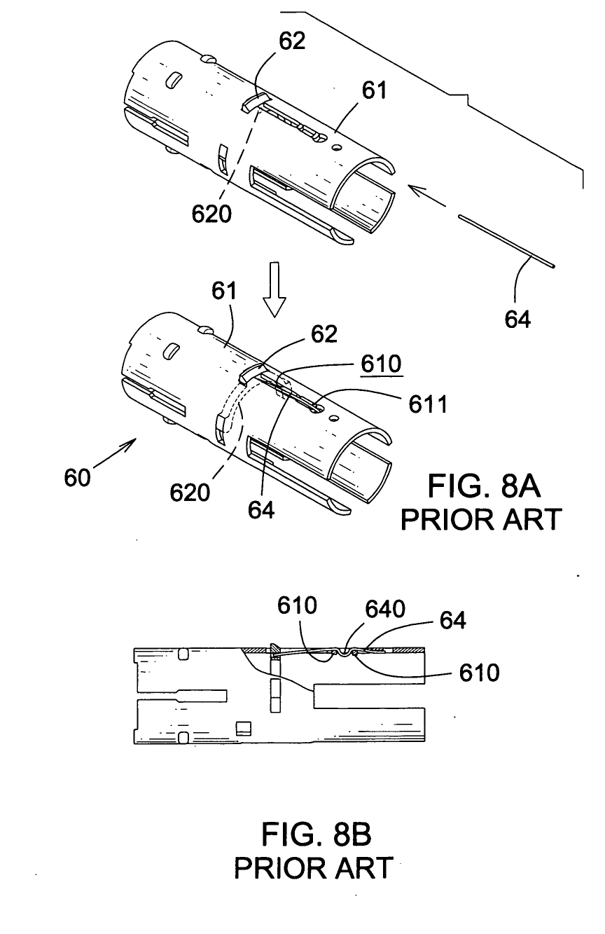

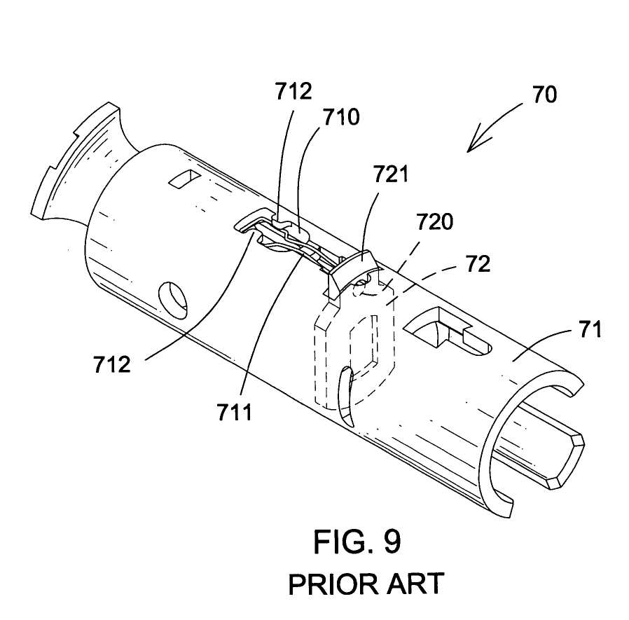

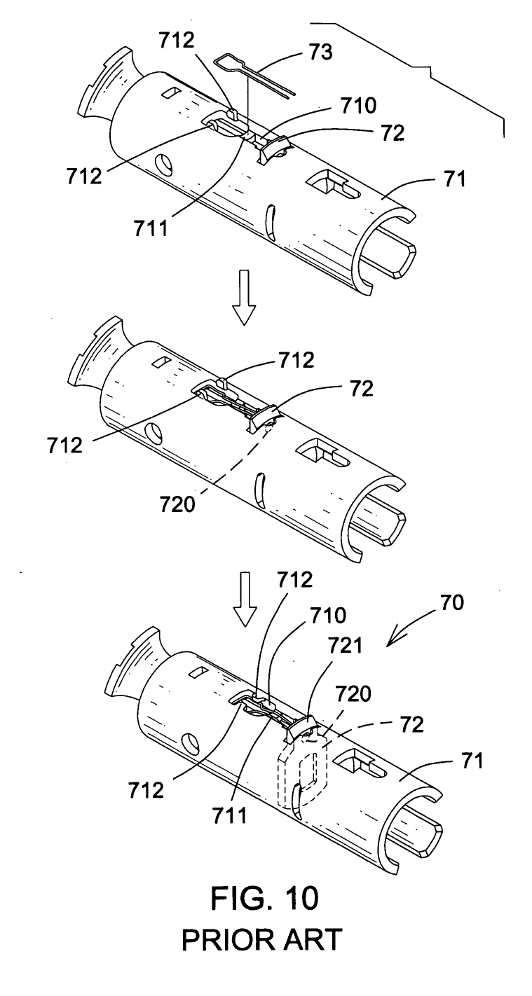

A second embodiment of this invention is disclosed, as shown in FIG. 5, wherein the rotation pipe (40) comprises a bushing (41) with a slot (410) defined therein, an arrester (42) mounted on the bushing (41) in a distal end of the slot (410), and a compression spring (43) secured in the slot (410). A jack (420) is defined in the arrester (42), and extends through two sides of the arrester (42), and a side channel (412) is defined at a proximal section of the slot (410). Furthermore, an extended portion is formed in a proximal end of the slot (410), and a groove (413) is defined in the extended portion. Two supporters (411) are formed below the slot (410) to hold the compression spring (43). A middle section of the compression spring (43) is previously made to curve downward to form a kink (430) that is located between the two supporters (411). With the engagement between the kink (430) and the supporters (411), the compression spring will not slide out from the slot (410). The distal end of the compression spring (43) is inserted into the jack (420), and the proximal end of the compression spring (43) is secured in the side channel (412) by deforming the compression spring (43), and finally, the proximal end is fitted into the groove (413).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A rotation pipe of a handle comprising a bushing (11), an arrester (20) mounted on the bushing (11), and a compression spring (30), wherein an axial extended slot (110,410) with two closed ends is defined in the bushing (11), a distal end of the slot (110,410) has a notch (111) defined therein, from which a lug (21) of the arrester (20) stands out, and a supporter (113) curved downward is formed below the slot (110,410); and
wherein, a side channel (112) is defined in a proximal end of the slot (110,410), and the compression spring (30) is immovably secured in the slot (110,410).

2. The rotation pipe of a handle as referred in claim 1 wherein the arrester (20) has a first blind hole (22) open to the slot (110,410), and a side channel (112) is defined in a proximal end of the slot (110,410), and in a proximal wall of the side channel, a second blind hole (114) is defined therein, and a supporter (113) is formed between two sides of the slot (110,410).

3. The rotation pipe of a handle as referred in claim 1, wherein a jack (420) is defined in the arrester (42), and two supporters (411) are formed below the slot (410), a curve section (430) formed in the compression spring is located between the two supporters (411);
a distal end of the compression spring (43) is inserted to the jack (420), and a proximal end of the compression spring (43) is located at the proximal end of the slot (410) and being pressed by an inner wall of the bushing.

4. The rotation pipe of a handle as referred in claim 3, wherein an extended portion is formed in the proximal end of the slot (410), and a groove (413) is defined in the extended portion.
